(19) United States
(12) Patent Application Publication
(10) Pub. No.: US 2009/0094494 A1
(43) Pub. Date: Apr. 9, 2009

(54) SEMICONDUCTOR INTEGRATED CIRCUIT AND METHOD OF TESTING SAME

(75) Inventor: Toshio Takeshima, Nakahara-ku (JP)

Correspondence Address: SUGHRUE MION, PLLC, 2100 PENNSYLVANIA AVENUE, N.W., SUITE 800, WASHINGTON, DC, 20037, US

(73) Assignee: NEC Electronics Corporation, Kanagawa (JP)

(21) Appl. No.: 12/245,395

(22) Filed: Oct. 3, 2008

(30) Foreign Application Priority Data
Oct. 4, 2007 (JP) 2007-260981

(51) Int. Cl. G06F 11/273

(52) U.S. Cl. 714/719; 714/E11.162

(57) ABSTRACT

A semiconductor integrated circuit includes a semiconductor memory circuit, an address input unit to generate an input address and to input the input address into the semiconductor memory circuit, the address input unit repeating generating and inputting from a start address to a end address, and an output data processor to select a select data and to count a value of the select data. The input address specifies data stored in the semiconductor memory circuit. The select data is a count object of output data read out from the semiconductor memory corresponding to the input address.

### BACKGROUND

1. Field of the Invention

The present invention relates to a semiconductor integrated circuit and a method of testing the same. In particular, the present invention relates to a testing device and a testing method to specify the location of a cell where a defect occurs in a semiconductor storage circuit.

2. Description of Related Art

A variety of techniques have been disclosed for testing devices and testing methods to detect defects in semiconductor storage devices such as ROMs (Read Only Memories). Among the related arts, Japanese Unexamined Patent Application Publication No. 4-258900 discloses a testing device for semiconductor memories capable of conducting an electrical characteristic test on a mask ROM even if the ROM has no pattern memory. FIG. 12 is a block diagram showing a testing device for semiconductor memories in the related art. Furthermore, FIG. 13 is a flowchart showing a testing method for mask ROMs in the related art. The testing device to test a semiconductor memory for electrical characteristics includes means 6a-6n to determine whether each of the output signals OD0 to ODn outputted from the DUT1 is “0” or “1”, each of which includes means 11a and 12a to successively sum up the totals of the numbers of the readouts of the data “0” and “1” respectively. Furthermore, the testing device compares the total sum values Sum1a−Sum1n and Sum0a−Sum0n with expected total sum values stored in an expected total sum value register 20 in order to determine whether the semiconductor memory is non-defective or defective.

Japanese Unexamined Patent Application Publication No. 2000-11700 discloses a testing method and a testing circuit for ROMs capable of determining whether memory data in a ROM is good or not at high speed while minimizing the increase in the scale of hardware. Japanese Unexamined Patent Application Publication No. 9-45100 discloses a testing device for nonvolatile memories capable of conducting a readout test in a short time and in a simple manner by eliminating the need for comparing actual readout data with expected data for each address in a successive manner.

However, although above-described techniques in the related art can detect whether ROMs are non-defective or defective, they cannot specify the locations where defects occur. Therefore, analyses to find the causes of defects have been very difficult. Furthermore, the analyses of the causes have not lead to improvements in the manufacturing processes of ROMs.

As explained above, there has been a problem that it is impossible to specify the locations where defects occur in semiconductor storage circuits.

### SUMMARY

A first exemplary aspect of an embodiment of the present invention is a semiconductor integrated circuit includes a semiconductor memory circuit, an address input unit to generate an input address and to input the input address into the semiconductor memory circuit, the address input unit repeating generating and inputting from a start address to a end address, and an output data processor to select a select data and to count a value of the select data. The input address specifies data stored in the semiconductor memory circuit. The select data is a count object of output data read out from the semiconductor memory corresponding to the input address.

In this manner, it is enable to specify the bit position and the address of a defective cell in a semiconductor storage circuit.

A second exemplary aspect of an embodiment of the present invention is a test method for a semiconductor integrated circuit comprising setting a start address and an end address, generating an input address based on the start address and the end address, the input address specifying data stored in a semiconductor memory circuit, reading an output data corresponding to the input address from the semiconductor memory circuit, selecting select data from the output data, the select data being a counting object, and repeating a process about each address, the process includes from generating the input address to counting the select data, the address is included from the start address to the end address.

The present invention enables to specify the location where a defect occurs in a semiconductor storage circuit.

### BRIEF DESCRIPTION OF THE DRAWINGS

The above and other exemplary aspects, advantages and features will be more apparent from the following description of certain exemplary embodiments taken in conjunction with the accompanying drawings, in which:

FIG. 1 is a block diagram showing an example of the structure of a semiconductor integrated circuit in accordance with one exemplary embodiment of the present invention;

FIG. 2 is a flowchart showing an example of the operation of the semiconductor integrated circuit in accordance with an exemplary embodiment of the present invention;

FIG. 3 shows examples of the values of cells and the count results;

FIG. 4 shows the setting values for each register to test the cells having values shown in FIG. 3;

FIG. 5 is a block diagram showing an example of the structure of a semiconductor integrated circuit in accordance with another exemplary embodiment of the present invention;

FIG. 6 shows an example of address conversion;

FIG. 7 shows examples of the results of tests using an address conversion circuit;

FIG. 8 shows an example in which the count results are different depending on the presence of an address conversion circuit;

FIG. 9 is a block diagram showing an example of the structure of a semiconductor integrated circuit in accordance with another exemplary embodiment of the present invention;

FIG. 10 is a block diagram showing an example of the structure of a semiconductor integrated circuit in accordance with another exemplary embodiment of the present invention;

FIG. 11 is a block diagram showing an example of the structure of a semiconductor integrated circuit in accordance with another exemplary embodiment of the present invention;

FIG. 12 is a block diagram showing a testing device for semiconductor memories in the related art; and

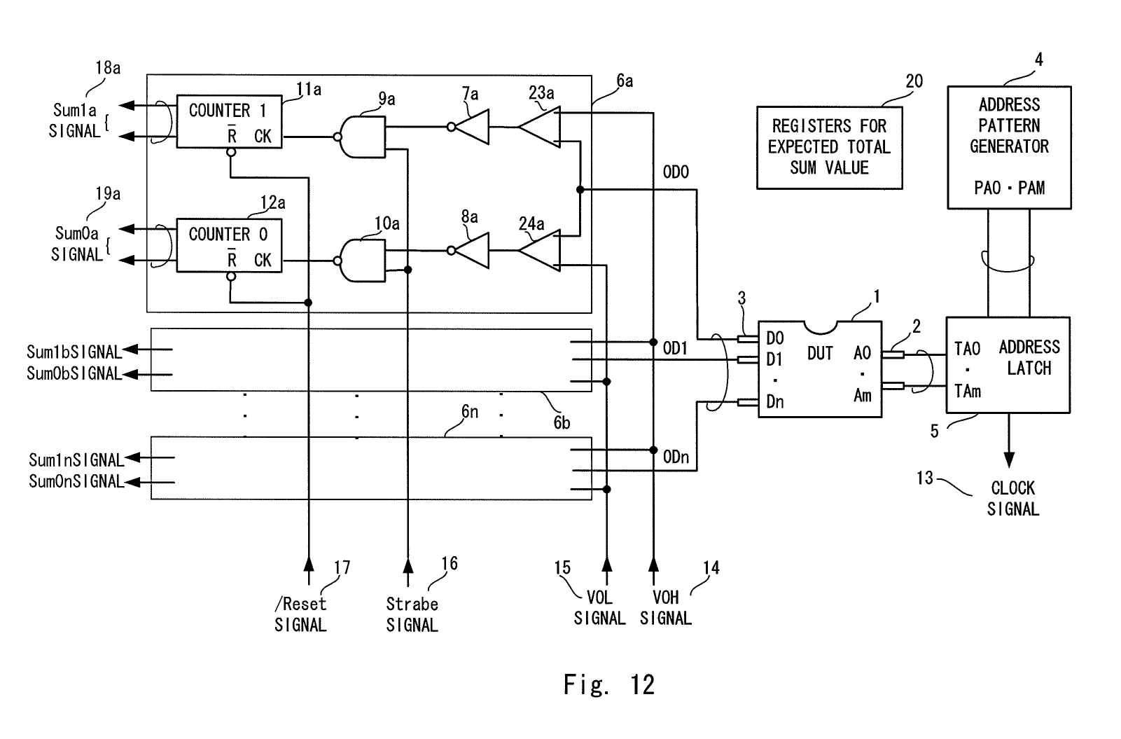

FIG. 13 is a flowchart showing a testing method for mask ROMs in the related art.

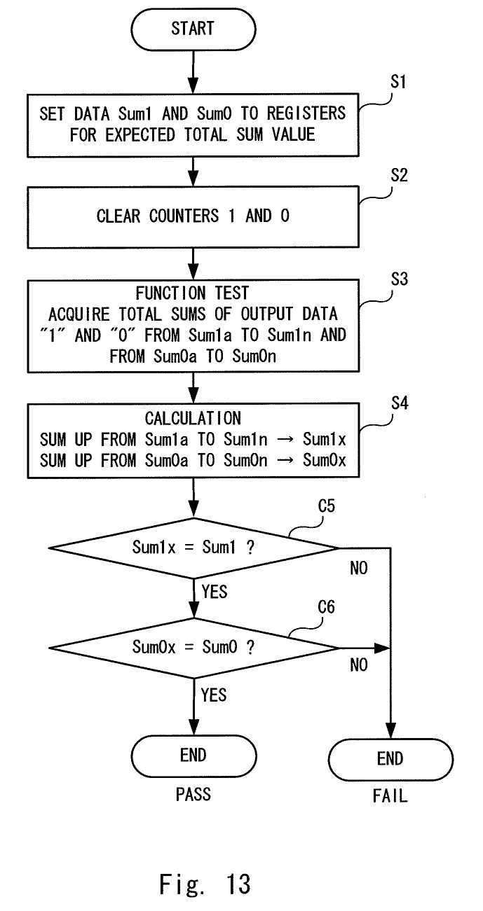

### DETAILED DESCRIPTION OF THE EXEMPLARY EMBODIMENTS

Exemplary embodiments of the present invention are explained hereinafter with reference to the drawings. Some parts of the following descriptions and the drawings are omitted or simplified as appropriate for the simplification and clarification of the explanation. The same signs are assigned to the same components or components having the same functions throughout the drawings, and the explanations of them are omitted as appropriate.

The following terms are used in the specification of the present application. “An address” designates the area where readout is carried out in a semiconductor storage circuit. Assume that readout is carried out on a “word” basis in the following explanations. Upon input of an address to the semiconductor storage circuit, it outputs data designated by the address on a word basis. “A bit width” means the number of bits contained in one word that is read out by using an address, and the minimum unit is one bit. “A bit position” designates the ordinal position of the bit within the data that is read out on a word basis. “A cell” means the minimum unit of a semiconductor storage circuit, and is an area corresponding to one bit that is uniquely designated by an address and a bit position.

Furthermore, a semiconductor storage circuit is a memory in which each cell can be specified by an address and a bit position, and includes, for example, a ROM, and a RAM (Random Access Memory). Exemplary embodiments of the present invention are explained hereinafter.

In one exemplary embodiment, a semiconductor integrated circuit and a method of testing the same in accordance with one aspect of the present invention is explained using a ROM as an example of the semiconductor storage circuit.

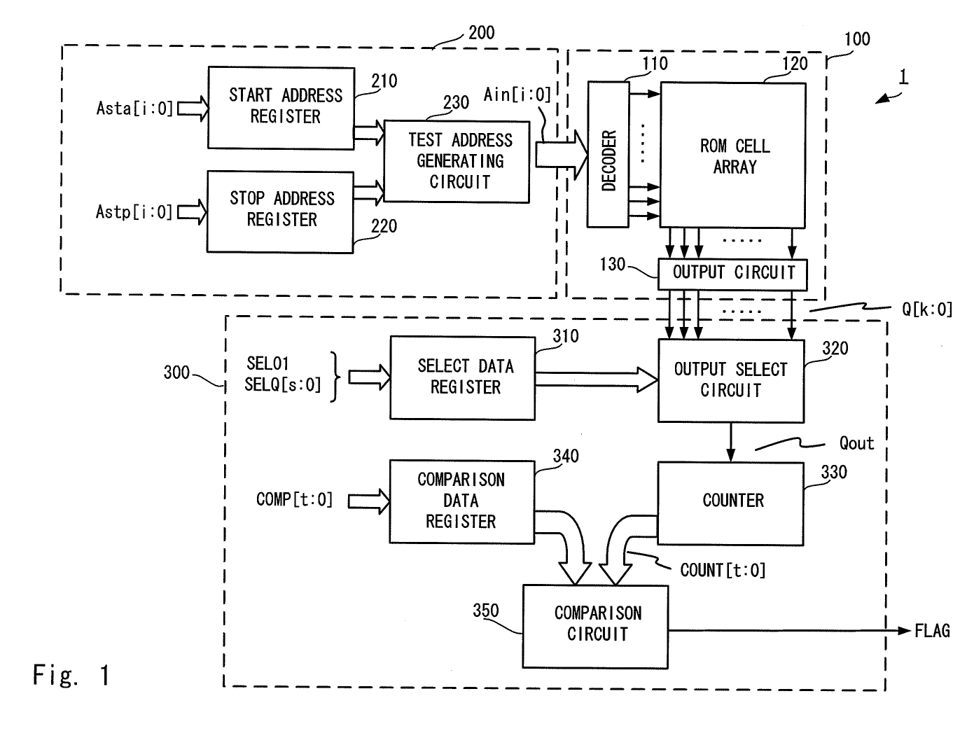

FIG. 1 is a block diagram showing an example of the structure of a semiconductor integrated circuit in accordance with one exemplary embodiment of the present invention. This exemplary embodiment of the present invention relates to a method of testing a semiconductor integrated circuit (e.g., ROM) capable of carrying out a test without the need for comparing the pattern date written in the ROM and thereby at a high speed, and also capable of detecting the bit position where a defect occurs. The semiconductor integrated circuit 1 in FIG. 1 includes a ROM (ROM to be tested) 100, an address input portion 200, and an output data processing portion 300. Each component shown in FIG. 1 is provided on a chip.

The ROM 100 includes a decoder 110, a ROM cell array 120, and an output circuit 130. The ROM 100, upon input of an address Ain[i:0] from the decoder 110, outputs one-word data Q[k:0] (k is the value calculated by subtracting 1 from the bit width) designated by the inputted address, among data retained in the ROM cell array 120, from the output circuit 130.

The address input portion 200 includes a start address register 210, a end address register 220, and a test address generating circuit 230. The start address register 210 stores a start address Asta[i:0]. The end address register 220 stores a end address Astp[i:0]. The test address generating circuit 230 receives a start address and an end address from the start address register 210 and the end address register 220 respectively, generates a test address Ain[i:0], and outputs it to the decoder 110.

The output data processing portion 300 includes a select data register 310, an output select circuit (output select portion) 320, a counter 330, a comparison data register 340, and a comparison circuit (comparison portion) 350. The select data register 310 stores an output select signal SELQ[s:0], which is used to select a target bit to be counted from an output signal, and a count value select signal SEL01, which is used to select the logical level to be counted (1 or 0). The output select signal SELQ[s:0] is a signal that is used to select the same bit position at all addresses. In the case where the number of addresses to be read out is eight, i.e., from 0 to 7, and the first bit position, for example, is to be designated, eight data each located at the first bit position in each of all the addresses are selected by the output select signal SELQ[s:0]. Incidentally, two or more bit positions may be selected simultaneously by the output select signal SELQ[s:0] as explained later. Although multiple bits are selected in such a case like that, they can be handled simultaneously by, for example, preparing multiple counters. The output select circuit 320 selects a target bit to be counted from the output signal outputted from the output circuit 130. Specifically, it outputs the target bit to be counted as a select data Qout in accordance with the output select signal retained in the select data register 310 and the count value select signal. That is, although eight data are selected by the output select signal SELQ[s:0], only the bits having the logical level designated by the count value select signal SEL01 among the eight data are outputted as the bits to be counted (select data Qout) in this example. The counter 330 counts the values of the select data Qout, and outputs the count result as a count data COUNT[t:0]. The comparison data register 340 stores a comparison data COMP[t:0], which is used as the expected value for the count result outputted from the counter 330. The comparison circuit 350 compares the count data with the comparison data, and outputs the comparison result as a match signal FLAG.

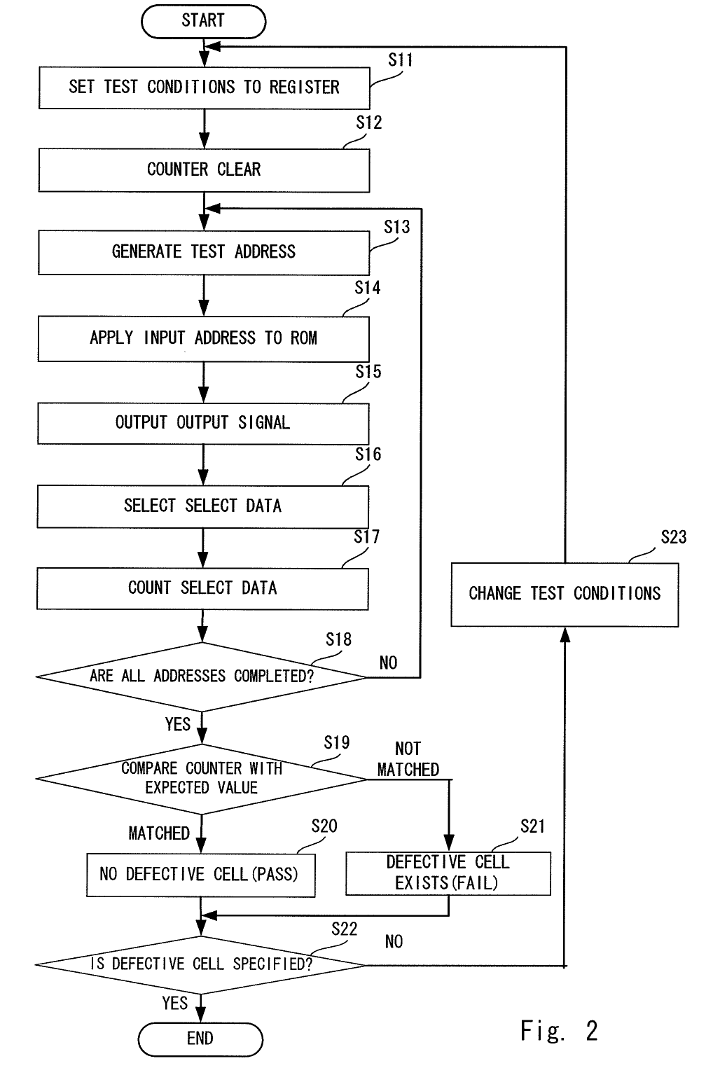

Next, the operation of a semiconductor integrated circuit in accordance with this exemplary embodiment of the present invention is explained hereinafter. FIG. 2 is a flowchart showing an example of the operation of the semiconductor integrated circuit in accordance with an exemplary embodiment. Firstly, test conditions are established (S11). Specifically, the select data register 310, the start address register 210, the end address register 220, and the comparison data register 340 are set to specified values. Furthermore, the counter 330 is cleared (S12).

Then, the test is carried out. Firstly, the test address generating circuit 230 is started to operate such that an address is successively generated as an input address Ain[i:0] between the start address and the end address (S13). The test address generating circuit 230 applies the input address to the ROM 100 (S14). The ROM 100 outputs data corresponding to the input address Ain[i:0] as an output signal Q[k:0] from the output circuit 130 (S15). The output select circuit 320 selects a target bit to be counted from the output signal based on the output select signal SELQ[s:0] and the count value select signal, and outputs it to the counter 330 (S16). The counter 330 counts the target bit to be counted (S17). The counter 330 determines whether all addresses in the area designated by the start address and the end address are generated or not (S18). If there are still addresses that are not generated (No at S18), the processes are repeated from the step S13, and if all addresses have been generated (Yes at S18), the process proceeds to the step S19.

The comparison circuit 350 compares the count data COUNT[t:0] counted by the counter 330 with the comparison data COMP[t:0] (S19), and determines that there is no defective cell (pass) when they are matched (S20), and that there is a defective cell (fail) when they are not matched (S21). The comparison circuit 350 determines whether the defective cell (fail cell) is specified or not (S22). If the defective cell is not specified, the test conditions are changed (S23), and the processes are repeated from the step S11 with the different setting values for the registers.

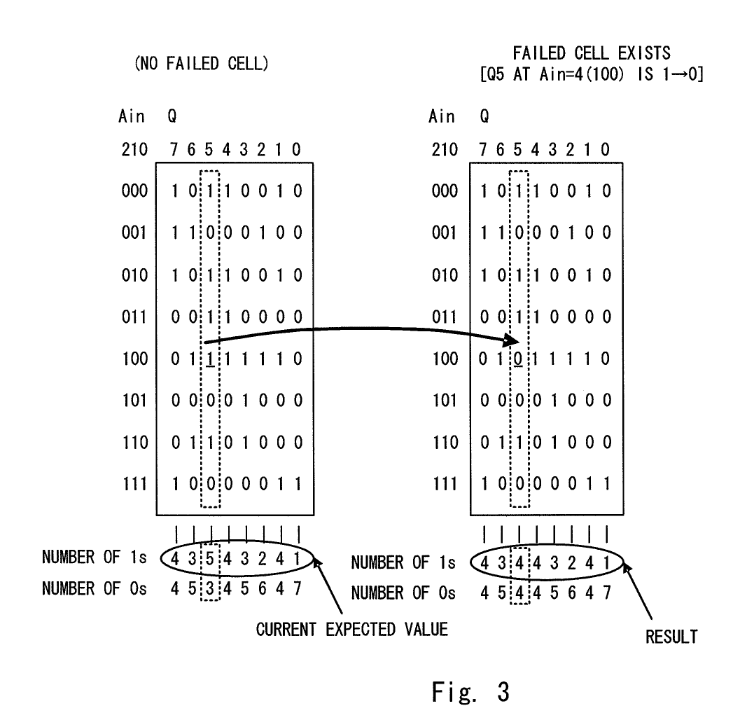

Next, a specific test flow is explained hereinafter using specific values of cells. FIG. 3 shows examples of the values of cells and the count results. In particular, FIG. 3 shows a value of each cell having an 8-bit width (bit position Q from 0 to 7) in the address area corresponding to the addresses (Ain) 000 to 111 of the ROM cell array 120 within the box, and the values obtained by counting the numbers of 1s and 0s (count results) under the box. The left side of FIG. 3 shows a case where there is no defective cell, and the right side shows a case where the fifth bit at the address 100 is defective.

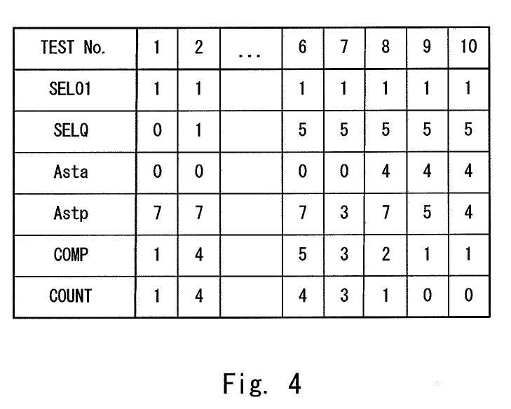

The flow of a testing method is explained hereinafter with reference to FIGS. 2 and 3. The testing method is divided into (1) a step to specify a defective bit, and (2) a step to specify a defective address in the following explanations. Furthermore, the specific operations in each test are carried out in accordance with the operations explained above with reference to FIG. 2. Firstly, (1) the step to specify a defective bit is explained hereinafter. In this step, the ordinal bit position of the defective cell is detected. Firstly, test conditions are established. FIG. 4 shows the setting values for each register to test the ROM 100 having values shown in FIG. 3. In this example, values for the count value select signal SEL01, the output select signal SELQ, the start address Asta, the end address Astp, and the comparison data COMP, as well as the count results of the count data COUNT are shown in the figure.

Firstly, the test conditions shown at Test No. 1 in FIG. 4 are established (S11), and the counter is cleared (S12). Then, the test is carried out (S13 to S18). The count result is compared with the comparison data (S19), and the comparison result is obtained (S20 and S21). Since the value of the COMP is matched with the value of the COUNT, the comparison result becomes a “pass”. Since there is no defective bit, the test is carried out again with different test conditions (No at S22). Then, the test is repeated for the test conditions at Test No. 2 and subsequent test numbers. At Test No. 6, since the value of the COMP is not matched with the value of the COUNT, the comparison result becomes a “fail”. That is, it is detected that a defective bit exists at the fifth bit position. At this point, (1) the step to specify a defective bit is completed.

Next, the process proceeds to (2) the step to specify a defective address. In the following tests, the output select signal SELQ designates the fifth bit at which the defect was detected until the defective address is specified. Firstly, after the test conditions at Test No. 7 are established, similar operations are carried out to obtain the comparison result. At Test No. 7, the target area of the test is the first half portion (0-3) of the entire address area designated by the start address and the end address. Since there is no defective cell and the comparison result becomes a “pass”, the test is repeated for a different address. The second half portion (4-7) of the entire address area is tested at Test No. 8. Since the comparison result becomes a “fail”, the test is repeated while the target address area is set to the address area 4-5 at Test No. 9. Since the comparison result becomes a “fail”, the test is repeated while the target address area is set to the address area 4 at Test No. 10. The comparison result becomes a “fail”. At this point, it is detected that the defective address is the address 4. Although a technique where the test is carried out by dividing the entire address area is into two sections is explained in this example, the present invention is not limited to this technique. That is, a technique where the address is incremented one by one, or other techniques can be used with the present invention.

As explained above, the technique where an arbitrarily start address and an arbitrarily end address are firstly established; then, data are counted on the basis determined by the number of output terminals (bits) of the ROM 100; and finally, the count results are compared with the expected values is used in an exemplary embodiment of the present invention. In this manner, when a defective cell is found, the bit position and the address of the defective cell can be obtained by repeating the test with a different test area (start address and end address). Therefore, the location of the defective cell can be specified.

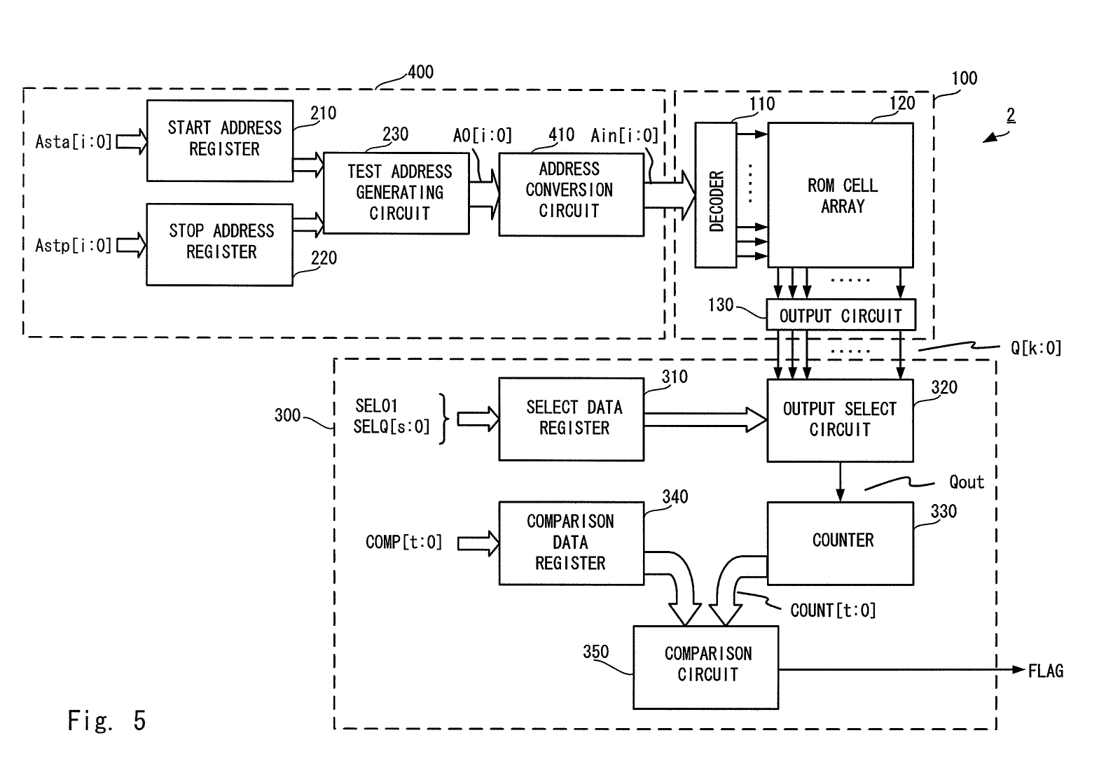

As another exemplary embodiment in accordance with the present invention, an exemplary embodiment in which the address input portion 200, which is explained with the one exemplary embodiment, has an address conversion circuit is explained hereinafter. FIG. 5 is a block diagram showing an example of the structure of a semiconductor integrated circuit in accordance with another exemplary embodiment of the present invention. Each component shown in FIG. 5 is provided on a chip. A semiconductor integrated circuit 2 is different from the semiconductor integrated circuit in the one exemplary embodiment in that the address generating portion 400 includes an address conversion circuit 410. Since the components having the same signs are similar to the components in the previous exemplary embodiment, the explanations of them are omitted as appropriate. In the address generating portion 400 shown in FIG. 5, the address outputted from the test address generating circuit 230 is shown as a test address A0[i:0], and the address outputted from the address conversion circuit 410 is shown as an input address Ain[i:0].

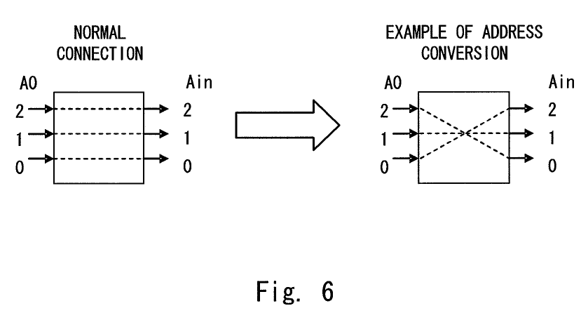

The address conversion circuit 410 converts the test addresses into the input addresses. Although a particular conversion method may be determined as appropriate depending on its address conversion circuit 410, FIG. 6 shows one example of such conversion methods. The left side of FIG. 6 shows a case of a normal connection, and the right side shows a case where an address is converted. Specifically, an example is shown where the test address A0=2 is converted to the input address Ain=0, and the test address A0=0 is converted to the input address Ain=0, i.e., an example where the addresses 0 and 2 are interchanged with each other.

The operation of the semiconductor integrated circuit 2 is identical to that of the semiconductor integrated circuit in the one exemplary embodiment except for the following points. In the operations shown in FIG. 2, the address conversion circuit 410 receives a test address from the test address generating circuit 230, generates an input address by carrying out address conversion on the inputted test address, and applies the generated input address to the ROM 100.

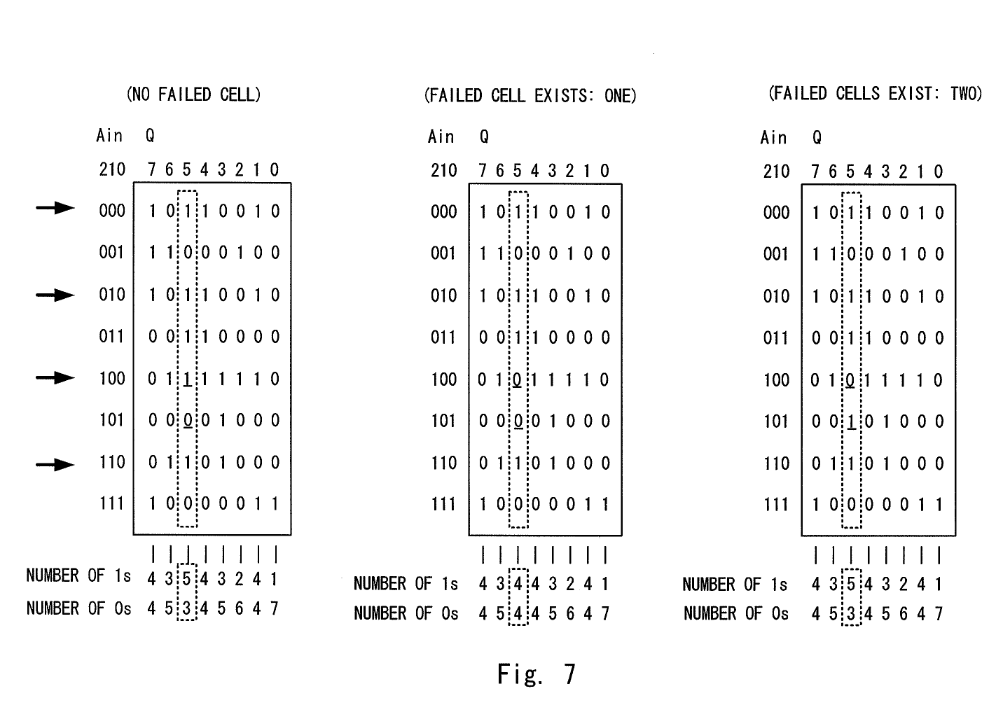

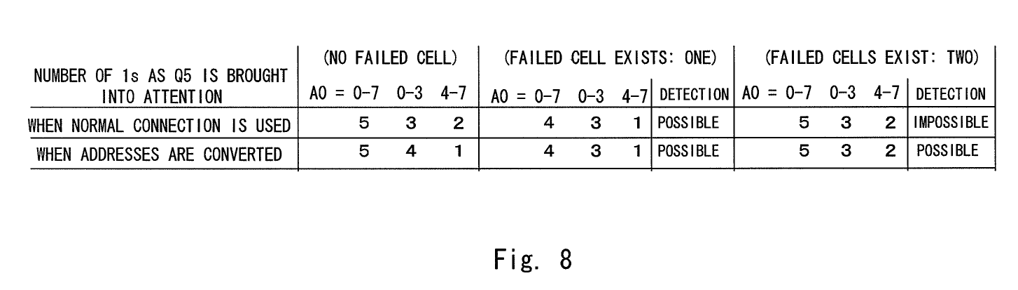

FIG. 7 shows examples of the values of cells and the test results. Specifically, FIG. 7 shows, from the left to the right, a case where there is no defective cell, a case where there is one defective cell, and a case where there are two defective cells. Furthermore, FIG. 7 shows a value of each cell in the address area corresponding to the addresses 000 to 111 of the ROM cell array 120 within the box, and the values obtained by counting the numbers of 1s and 0s under the box. FIG. 8 shows an example in which the count results are different depending on the presence of the address conversion circuit 410. In particular, FIG. 8 shows the count results in the case where the select data is located at the bit position Q=5 and the addresses are converted in accordance with the address conversion shown in FIG. 6 when the address conversion circuit 410 is connected. As shown in FIG. 8, no problem arises when there are an odd number of defective cells as in the case where there is one defective cell (as shown at the center in FIG. 7). However, when there are an even number of defective cells as in the case where there are two defective cells (as shown on the right side in FIG. 7), the count results are identical to those in the case where there is no defective cell in the normal connection. Therefore, the defective cells cannot be detected. Meanwhile, the count results are different from those in the case where there is no defective cell when the addresses are converted. Therefore, the defective cells can be detected.

In this manner, a failure in the detection of defective cells can be prevented even in the case where there are an even number of defective cells by inserting the address conversion circuit 410 in the address generating portion 400. That is, defective cells can be found in a more precise manner by activating the address conversion circuit. Furthermore, the address conversion circuit 410 may be configured such that it is externally activated or deactivated, so that count results can be easily obtained in both the case where the address conversion circuit 410 is activated to convert addresses and the case of the normal connection where the address conversion circuit 410 is not activated. Incidentally, FIG. 6 shows merely one example of the address conversion, and the address conversion method is not limited to this exact example.

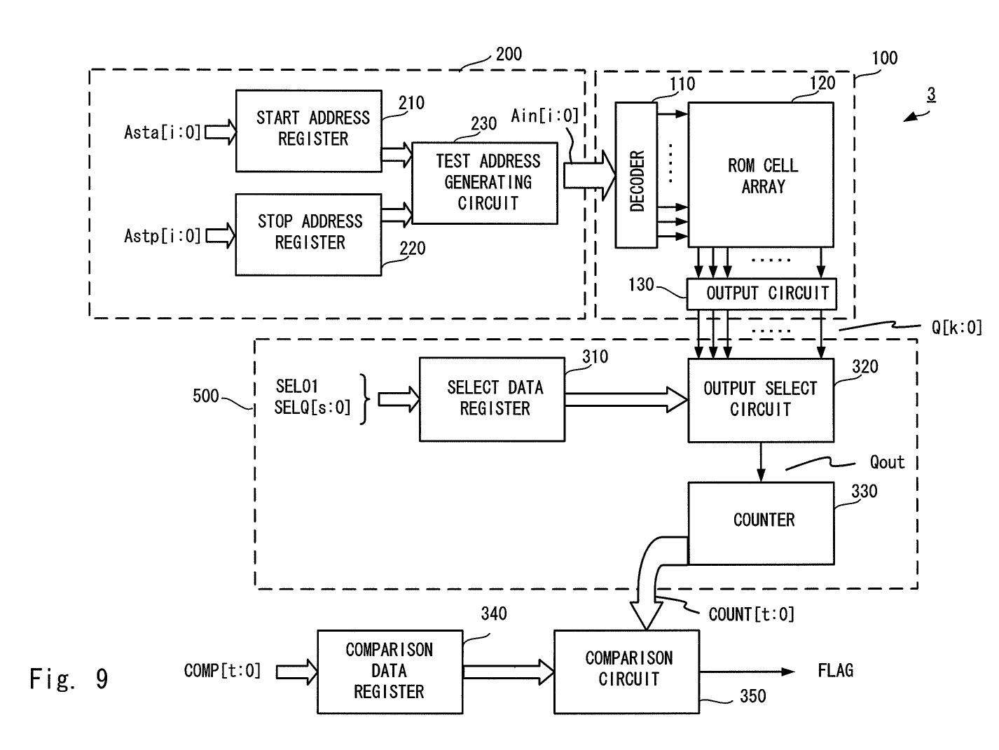

As another exemplary embodiment in accordance with the present invention, an embodiment in which the comparison circuit 350 and the comparison data register 340 are removed from the output data processing portion 300, which is explained with the one exemplary embodiment, and the output data processing portion 300 externally outputs the count results counted by the counter is explained hereinafter. FIG. 9 is a block diagram showing an example of the structure of a semiconductor integrated circuit in accordance with another exemplary embodiment of the present invention. A semiconductor integrated circuit 3 does not includes the comparison circuit in the output data processing portion 500, and outputs the count data externally to the tester or a similar external device. Other function and operation of each component are similar to those in the previously discussed exemplary embodiment, and the explanations of them are omitted. As shown in FIG. 9, the comparison data register 340 and the comparison circuit 350 are not provided within the semiconductor integrated circuit 3, but provided externally in the external tester or a similar external device. The remaining components are provided on the chip.

When the test circuit 3 for semiconductor storage devices shown in FIG. 9 is used, the count data is inputted to the tester, so that the tester determines the presence of a defective cell.

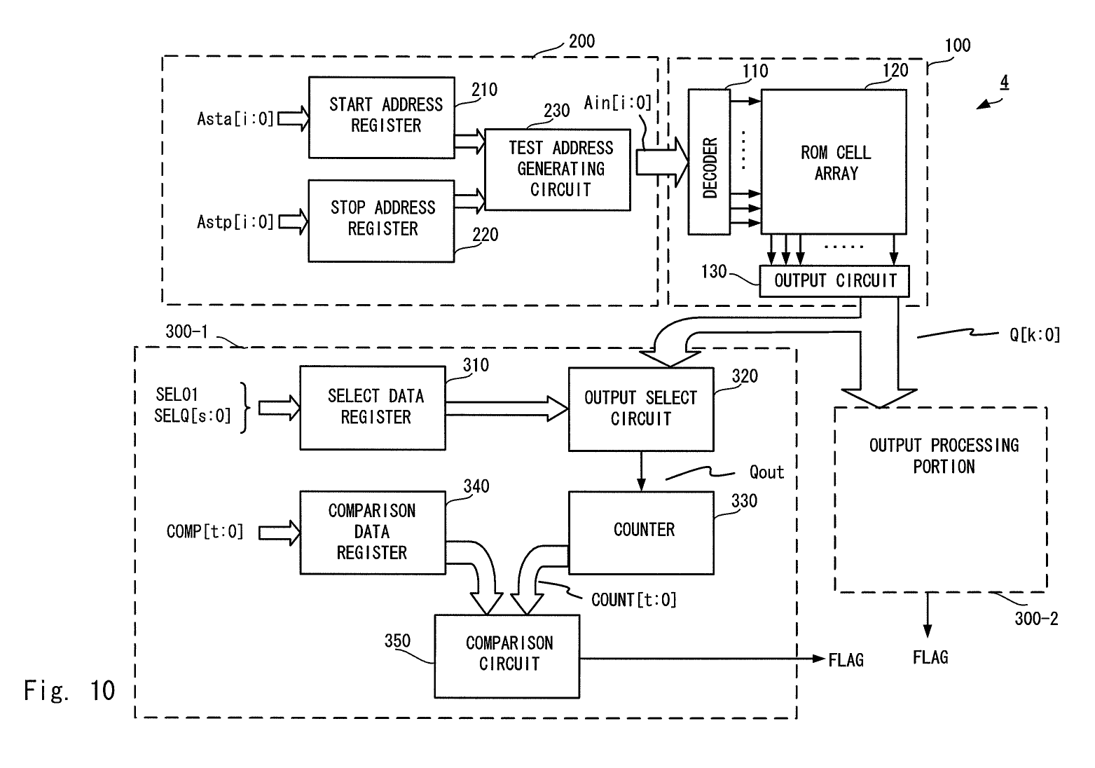

As another exemplary embodiment in accordance with the present invention, an exemplary embodiment having several data processing portions is explained hereinafter. FIG. 10 is a block diagram showing an example of the structure of a semiconductor integrated circuit in accordance with another exemplary embodiment of the present invention. Each component shown in FIG. 10 is provided on a chip. The exemplary embodiment shown in FIG. 10 includes several output data processing portions 300. Although FIG. 10 shows another exemplary embodiment having two output data processing portions 300-1 and 300-2, other exemplary embodiments may include more than two output data processing portions 300. Alternatively, the output data processing portion 300 may include several sets of the output data processing portions 500 shown in FIG. 9, the comparison data registers 340, and the comparison circuits 350.

By equipping with several output data processing portions 300 in such a manner, such an exemplary embodiment can carry out several tests in parallel, and thereby reducing the testing time. However, this exemplary embodiment requires a larger and more complex circuit and higher cost. Therefore, the number of the output data processing portions 300 is preferably determined based on its priority against the testing time. Incidentally, although FIG. 10 shows another exemplary embodiment having several output data processing portions 300, other exemplary embodiments may include several output data processing portions 500 shown in FIG. 9. In other words, the only necessary requirement is that the counters 330 should be provided for select data at their respective one of the plural bit positions so that select data values at each bit position can be counted.

Furthermore, although FIG. 10 shows another exemolary embodiment having several output data processing portions 300, other exemplary embodiments may only include several counters 330. For example, in the exemplary embodiment shown in FIG. 9, the output select circuit 320 may select data at plural bit positions with the output select signal SELQ, and output each of the select data at different bit positions to corresponding one of plural counters. Each of the counters may count data from the bit position assigned to that counter, and output the count data COUNT. With such a structure, plural count results at different bit positions can be obtained simultaneously. Furthermore, other exemplary embodiments may include plural counters 330, plural comparison data registers 340, and plural comparison circuits 350, in addition to plural output select circuits, which output select data at plural bit positions to the corresponding counters.

In each of the above-described exemplary embodiments, a case where the output select circuit 320 selects one select data and outputs it to the counter 330 in the output data processing portion 300 is explained. However, the output select circuit 320 may select select data at plural bit positions, and the counter 330 may sum up the count data at plural bit positions together. Specifically, several bit positions are designated in the output select signal SELQ[s:0] of the select data register 310. The output select circuit 320 outputs data at plural bit positions designated by the SELQ[s:0] to the counter 330 as the select data Qout. The counter 330 counts the inputted select data Qout at plural bit positions, and output the count data. For example, the entire bit positions are divided into halves and each half portion is tested. Then, the bit positions corresponding to the half portion where a defective cell is detected are further divided into halves and each half portion is tested. The bit position where the defective cell exists is detected by repeating these processes. Alternatively, two (or more than two) bit positions may be testes together. Then, the plural bit positions where a defective cell is detected may be further tested to specify the bit position where the defective cell exists. After the bit potion where the defective cell exists is detected, the address where the defective cell exists may be specified by carrying out a similar operation to the operation explained above with the one exemplary embodiment.

In this manner, the combinations of plural bit positions are firstly tested so that the area corresponding to plural bit positions where a defective cell exists can be specified. As a result, the process, in which the presence of a defective cell is firstly detected and then the decision whether the test to specify the location of the defective bit is necessary or not is made, becomes easier in comparison to the case where test is carried out on a bit-by-bit basis.

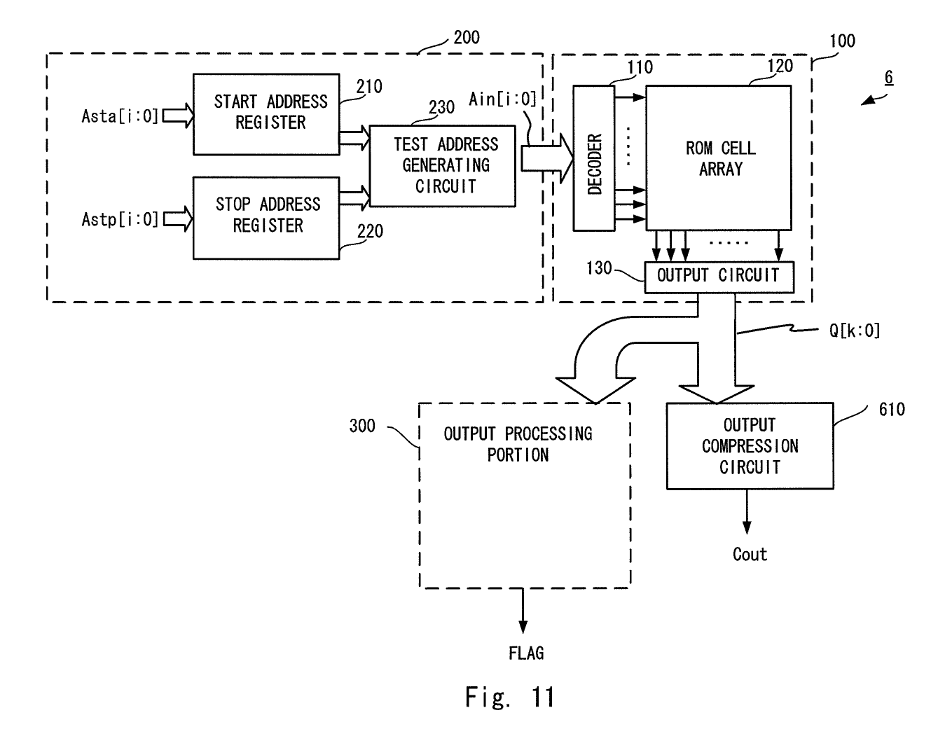

In each of the above-described exemplary embodiments, the semiconductor integrated circuit may include an output compression circuit to compress output data outputted from the output circuit 130. FIG. 11 is a block diagram showing an example of the structure of a semiconductor integrated circuit in accordance with another exemplary embodiment of the present invention. Each component shown in FIG. 11 is provided on a chip. A semiconductor integrated circuit 6 further includes an output compression circuit 610. The output compression circuit 610 compresses data Q[k:0] outputted from the output circuit 130, and outputs the compressed data as Cout. The output compression circuit 610 may be constructed, for example, by referring the examples described in “One Experiment on Alias Error in Mask ROM BIST” (The Institute of Electronics, Information and Communication Engineers Technical Research Report FTS93-17, The Institute of Electronics, Information and Communication Engineers, June, 1993, pages 33-39).

The compressed data Cout is taken out after the test addresses corresponding to the entire address space are generated, and is compared with the expected value that is calculated in advance in order to determine the pass/fail (presence of a defective cell) of the ROM 100. When it is determined that there is a defective cell, the bit position and the address of the defective cell is specified through the procedure shown in each of the above-described exemplary embodiments. Incidentally, the comparison with the expected value may be carried out by setting the expected value in advance in the above-mentioned comparison data register.

As explained above, by equipping with the output compression circuit 610, the pass/fail of the ROM 100 to be examined can be firstly determined, and then the test to specify the bit position and the address of the defective cell can carried out for the ROM that is found out to have a defective cell. In this manner, it is enabled to select the ROMs 100 that require further examinations, and therefore it can improve the efficiency of the examinations in comparison to the case where the test is carried out on a cell basis from the beginning.

Although the ROM 100 is used as one example of the semiconductor storage circuit in each of the above-described exemplary embodiments, the present invention may be applied to the case where a RAM is used as the semiconductor storage circuit. However, when a RAM is tested, data must be written in the RAM before the test is started.

Furthermore, the ROM in which cells are specified with bit positions and addresses is explained as an example in each of the above-described exemplary embodiments. However, bit positions and addresses are merely one example of techniques to specify the minimum units (cells) of a semiconductor storage circuit, and other techniques may be used to specify the minimum units. The present invention is applicable to any of such cases, provided that two factors are used to specify the minimum units of a semiconductor storage circuit in those cases.

Furthermore, although the output data processing portion 300 is used in the exemplary embodiments shown in FIGS. 5 and 11, the output data processing portion 500 used in other exemplary embodiments or a similar output processing portion may be used as a substitute. Similarly, the address input portion 200 is used in the exemplary embodiments shown in FIGS. 9, 10, and 11, the address generating portion 400 shown in FIG. 5 may be used as a substitute.

As has been described above, the location of a defective cell in a semiconductor storage circuit can be detected by carrying out the test on the semiconductor storage circuit with specified bit positions and specified addresses in accordance with one exemplary embodiment of the present invention. Therefore, it can not only determine the pass/fail of a semiconductor storage circuit, but also specify the location of the defect. Accordingly, it may be expected to be used as one factor to analyze the cause of a defective cell. Further, the above exemplary embodiments can be combined as desirable by one of ordinary skill in the art.

While the invention has been described in terms of several exemplary embodiments, those skilled in the art will recognize that the invention can be practiced with various modifications within the spirit and scope of the appended claims and the invention is not limited to the examples described above.

Further, the scope of the claims is not limited by the exemplary embodiments described above.

Furthermore, it is noted that, Applicant's intent is to encompass equivalents of all claim elements, even if amended later during prosecution.

What is claimed is:

1. A semiconductor integrated circuit comprising:
a semiconductor memory circuit;
an address input unit which generates an input address and inputs the input address into the semiconductor memory circuit, wherein the address input unit repeats the generating and the inputting from a start address to an end address, and the input address specifies data stored in the semiconductor memory circuit; and
an output data processor which selects a select data and counts a value of the select data, the select data being a count object of output data read out from the semiconductor memory corresponding to the input address.

2. The semiconductor integrated circuit according to claim 1, wherein the address input unit comprises:
a start address register which stores the start address;
a end address register which stores the end address; and
a test address generator which repeats the generating the input address specifying each address from the start address to the end address.

3. The semiconductor integrated circuit according to claim 1, wherein the address input unit further comprises an address conversion circuit which converts an input address generated by the address generation circuit into another address mutually.

4. The semiconductor integrated circuit according to claim 1, wherein the output data comprises more than two bits, and the output data processor comprises:
an output selection circuit which selects a bit having a some bit position and a some logical level as the select data, from the output data based on an output select signal specifying at least one bit position and a count value select signal specifying the logical level; and
a counter which repeats counting a value of the select data selected by the output selection circuit for each address from the start address to the end address.

5. The semiconductor integrated circuit according to claim 4, wherein the output data processor further comprises:
a comparison circuit which compares a value counted by the counter with an expected value held previously and outputs a comparison result.

6. The semiconductor integrated circuit according to claim 4, wherein the output select signal specifies one bit position and the counter repeats counting a value of the select data for each address from the start address to the end address.

7. The semiconductor integrated circuit according to claim 4, wherein the output select signal specifies a plurality of bit positions, the counter comprises a plurality of counters corresponding to a plurality of bit positions, and the plurality of counters repeat counting a value of the select data corresponding to each bit position for each address from the start address to the end address.

8. The semiconductor integrated circuit according to claim 4, wherein the output select signal specifies a plurality of bit positions and the counter repeats counting a value of the select data having the plurality of bit positions for each address from the start address to the end address.

9. The semiconductor integrated circuit according to claim 4, further comprising a plurality of the output data processors, wherein each output selection circuit provided in the plurality of the output data processors specifies a different bit position by the output select signal and outputs data having the different bit position and logical level as the select data, and each counter provided in the plurality of the output data processors counts a value of the select data having the different bit position.

10. The semiconductor integrated circuit according to claim 1, further comprising an output compression circuit which compresses the output data and outputs a value of compression data.

11. The semiconductor integrated circuit according to claim 1, wherein the semiconductor memory circuit is Read Only Memory (ROM).

12. The semiconductor integrated circuit according to claim 4, wherein the output data comprises word basis.

13. A test method for a semiconductor integrated circuit, the method comprising:
setting a start address and an end address;
generating an input address based on the start address and the end address, the input address specifying data stored in a semiconductor memory circuit;
reading an output data corresponding to the input address from the semiconductor memory circuit;
selecting select data from the output data, the select data being a counting object; and
repeating, for each address from the start address to the end address, the generating, the reading, and the selecting.

14. The test method for a semiconductor integrated circuit according to claim 13, wherein a bit having a bit position and a logical level is selected as the select data from the output data based on an output select signal specifying at least one bit position and a count value select signal specifying a logical level.
